(19) United States
(12) Patent Application Publication
(10) Pub. No.: US 2023/0298807 A1
(43) Pub. Date: Sep. 21, 2023

(54) Multilayer Inductor Construction

(71) Applicant: Steward (Foshan) Magnetics Co., Ltd., Foshan (CN)

(72) Inventors: Jacken ZHANG, Foshan City (CN); Yeat Shing CHIANG, Foshan City (CN); Wenshan PANG, Foshan (CN)

(21) Appl. No.: 18/117,198

(22) Filed: Mar. 3, 2023

(30) Foreign Application Priority Data
Mar. 21, 2022 (CN) 2022102768833

(51) Int. Cl. H01F 27/29; H01F 17/00

(52) U.S. Cl. CPC H01F 27/292; H01F 17/0013; H01F 2017/0066

(57) ABSTRACT

A multilayer inductor comprises a plurality of magnetic layers and metal electrode tracks formed on the magnetic layers. A ceramic-inorganic material composite is placed in the magnetic core area in the pattern of coils formed by the metal electrode tracks. The ceramic-inorganic material composite comprises two or more first layers and second layers. The first layers comprise a ceramic material having a positive slope of the dielectric constant versus temperature curve. The second layers comprise an inorganic material having a negative slope of the dielectric constant versus temperature curve. The first layers and the second layers are stacked on each other in an alternating manner. The metal electrode tracks are arranged in such a way that the void space between two adjacent metal electrode tracks where no effective magnetic lines of force exist is minimized. The multilayer inductor enables stable device characteristics and enhances the inductive performance.

### CROSS-REFERENCE TO RELATED APPLICATION

This application claims priority to and the benefit of Chinese Invention Patent Application No. 202210276883.3 filed Mar. 21, 2022. The disclosure of this application identified in this paragraph is incorporated herein by reference in its entirety.

### FIELD OF TECHNOLOGY

The present invention relates to the field of electronic devices, specifically to a multilayer inductor structure for power applications. In particular, the multilayer inductor is used for voltage to current conversion for power transmission, impedance matching for data transmission and processing, and filtering of electromagnetic interference.

### BACKGROUND ART

As one of the passive devices, inductors can usually be classified into: winding type inductors, which are manufactured by winding a coil around a ferrite core and forming electrodes at its ends; and multilayer type inductors, which are manufactured by printing an inner electrode on a magnetic or dielectric layer and then stacking the magnetic or dielectric layers together.

In recent years, the development of thick film printing processes and LTCC materials has led to the need for further miniaturization of passive devices such as resistors, capacitors, and inductors. In small circuit boards, multilayer inductors are gradually gaining dominance as the best SMT inductor solution for size miniaturization and low cost, compared to winding type inductors.

Typically, multilayer inductors consist of a single monolithic structure formed by a multilayer body consisting of multiple magnetic sheets (or strips) that undergo a high-temperature solid-phase reaction. The conductive electrodes can be formed as the coil pattern on the magnetic sheets by printing (but not limited to printing). With the development of technology, various aspects of research exist in the prior art to improve the multilayer inductor structures.

For this, U.S. Pat. No. 6,249,205 proposes a multilayer inductor that provides high inductance by introducing an air gap between the layers of the multilayer inductor. But such air gaps would cause problems in performance fluctuation of the inductor.

Therefore, the drawbacks of the multilayer inductors, e.g., inductance and impedance instability under different application conditions such as current, frequency, temperature, etc., have not been addressed in this field so far.

### SUMMARY OF THE INVENTION

### Technical Problem

In an aspect, generally, when preparing the body, non-magnetic ceramics are chosen in this field instead of the air gap to regulate the characteristics of the inductor and stability thereof. But there is a problem in that the characteristics of these non-magnetic ceramics will also deviate with temperature and frequency. In this regard, the applicant has found that the source of instability of non-magnetic ceramics in the gap position of the magnetic core area to current, temperature, and frequency is the deviation of the dielectric constant.

Therefore, a technical object of the present invention is to provide a ceramic-inorganic material composite that fills such gap positions, which can eliminate the deviation of the dielectric constant of the magnetic core with current, temperature, and frequency, thereby realizing a multilayer inductor structure with stable characteristics.

In another aspect, in the prior art, the multilayer inductor is manufactured by a process of printing metal electrode tracks on the magnetic sheet, utilizing static pressing, and then co-firing. Therefore, the thickness of the magnetic sheet should not be too small in consideration of the operability of this manufacturing process. As a result, there is a high percentage of void space between two adjacent layers of metal electrode tracks where no effective magnetic lines of force exist, giving no contribution to inductor performance. The applicant has found that the void space can be maximally compressed by reducing the space between the metal electrode tracks of two adjacent layers or by changing the arrangement of the metal electrode tracks.

Therefore, another technical object of the present invention is to provide a multilayer inductor that enables minimization of the void space where no effective magnetic lines of force exist, and thus enhances the characteristics of the multilayer inductor (e.g., enhancing the effective magnet utilization of the multilayer inductor), thereby enhancing the characteristics of the inductor, such as inductance value enhancement, current stability improvement, and impedance characteristic optimization of the inductor.

### Technical Solution

In order to solve the above technical problem, in an aspect, the present invention provides a ceramic-inorganic material composite for a multilayer inductor, which is located in the magnetic core area of metal electrode tracks present in the pattern of coils and comprises two or more first layers and second layers, wherein the first layers comprise a ceramic material having a positive slope in a curve of the dielectric constant versus temperature, the second layers comprise an inorganic material having a negative slope in a curve of the dielectric constant versus temperature, and the first layers and the second layers are stacked on each other in an alternating manner.

In this aspect, the ceramic material having a positive slope in a curve of the dielectric constant versus temperature can be almost any ceramic material commonly used in the art, for example, those selected from commercially available materials such as titanium dioxide, zirconium dioxide, etc.

The inorganic material having a negative slope in a curve of the dielectric constant versus temperature can be selected from commercially available materials, such as calcium carbonate, calcium bicarbonate, calcium oxide, etc.

The metal electrode comprises silver (Ag), platinum (Pt), palladium (Pd), copper (Cu), gold (Au), nickel (Ni), or alloys thereof, or composites thereof.

In this aspect, it further relates to a multilayer inductor comprising a plurality of magnetic layers and metal electrode tracks formed on the magnetic layers, wherein a ceramic-inorganic material composite is disposed in the magnetic core area formed by the metal electrode tracks in the pattern of coils, the ceramic-inorganic material composite comprises two or more first layers and second layers, wherein the first layers comprise a ceramic material having a positive slope in a curve of the dielectric constant versus temperature, the second layers comprise an inorganic material having a negative slope in a curve of the dielectric constant versus temperature, and the first layers and the second layers are stacked on each other in an alternating manner.

In the second aspect, the present invention provides a multilayer inductor comprising a plurality of magnetic layers and metal electrode tracks formed on the magnetic layers, wherein the metal electrode tracks are arranged in such a way that the void space between two adjacent metal electrode tracks where no effective magnetic lines of force exist is minimized.

According to the second aspect, the metal electrode tracks are arranged in such a way that multilayer metal electrode tracks of the multilayer inductor are closely arranged in the vertical direction, so that the overall thickness of the magnetic layers between the metal electrode tracks is 10 μm or less.

In the second aspect, the plurality of magnetic layers and metal electrode tracks are formed by printing, etching, and laser methods. Among them, in forming the plurality of magnetic layers and metal electrode tracks by multiple printing techniques, the thickness of the magnetic or metal layers is 5 μm or less for each printing.

According to the second aspect, alternatively, the metal electrode tracks are arranged in such a way that multilayer metal electrode tracks of the multilayer inductor are arranged in a stepwise mismatch on a cross section perpendicular to the plurality of magnetic layers.

Specifically, with respect to the metal electrode tracks of a lower layer, the metal electrode tracks of an upper layer are mismatched to the left or right layer by layer in a step-like manner.

The material of magnetic layers can be a ferrite material.

In the third aspect, the present invention provides a multilayer inductor comprising a plurality of magnetic layers and metal electrode tracks formed on the magnetic layers, wherein a ceramic-inorganic material composite is placed in the magnetic core area in the pattern of coils formed by the metal electrode tracks, the ceramic-inorganic material composite comprises two or more first layers and second layers, wherein the first layers comprise a ceramic material having a positive slope of the dielectric constant versus temperature curve, the second layers comprise an inorganic material having a negative slope of the dielectric constant versus temperature curve, and the first layers and the second layers are stacked on each other in an alternating manner; and the metal electrode tracks are arranged in such a way that the void space between two adjacent metal electrode tracks where no effective magnetic lines of force exist is minimized.

### Beneficial Effect

According to the first aspect of the present invention, the ceramic-inorganic material composite of the multilayer inductor of the present invention can eliminate the deviation of the dielectric constant of the core with current, temperature, and frequency, thereby realizing a multilayer inductor structure with stable characteristics.

According to the second aspect of the present invention, the void space between the metal electrode tracks of the multilayer inductor is minimized, thus allowing the available magnetic capacity of the core to increase and the DC resistance to decrease.

In addition, by aligning the metal electrode tracks closely, subsequent processes (e.g., sintering) can be performed without creating delamination or machine shrinkage rate anisotropy that can lead to product distortion, cracking, and unstable reliability.

According to a third aspect of the present invention, the multilayer inductors can improve the electrical and magnetic performances of the device while achieving stable characteristics, and thus enhances the effective magnet utilization of the multilayer inductor, thereby enhancing the characteristics of the inductor, such as inductance value enhancement, current stability improvement, and impedance characteristic optimization of the inductor.

### DESCRIPTION OF FIGURES

The accompanying drawings depicted herein are for the purpose of illustrating selected examples only, not all possible embodiments, and are not intended to limit the scope of the present invention.

FIG. 1A is a schematic perspective view of a multilayer inductor structure in the prior art.

FIG. 1B is a schematic cross-sectional view of a multilayer inductor structure in the prior art.

FIG. 2A is a schematic cross-sectional view of the ceramic-inorganic material composite of the present invention.

FIG. 2B is a schematic cross-sectional view of the multilayer inductor structure comprising the ceramic-inorganic material composite of the present invention.

FIG. 3 is a schematic cross-sectional view of the void space of a multilayer inductor structure of the prior art.

FIG. 4A is a schematic cross-sectional view of the multilayer inductor structure containing closely arranged multilayer metal electrode tracks of the present invention.

FIG. 4B is a partially enlarged view of the structure shown in FIG. 4A formed using the multiple printing technique.

FIG. 4C is a schematic cross-sectional view of a multilayer inductor structure formed by mismatched multilayer metal electrode tracks of the present invention and the distribution of magnetic lines of force therein.

FIG. 5 illustrates the impedance-frequency curve of the multilayer inductor obtained in Example 1.

FIG. 6 illustrates the inductance-current curve of the multilayer inductor obtained in Example 1.

FIG. 7A illustrates a schematic view of the effective magnetic lines of force of the multilayer inductor obtained in Comparative Example 1.

FIG. 7B illustrates a schematic diagram of the effective magnetic force lines of the multilayer inductor obtained in Example 1.

FIG. 8 illustrates the inductance-current curve of the multilayer inductor obtained in Example 3.

### DETAILED DESCRIPTION OF PREFERRED EMBODIMENTS

In the following, the present invention will be described in more detail.

It is to be understood that the terms used in the specification and claims may be construed to have a meaning consistent with their meaning in the context of the relevant field and the technical contemplation of the present invention, based on the principle that they may be appropriately defined by the inventor. The terms used in the specification are intended to explain exemplary embodiments only and are not intended to limit the invention.

It is further understood that, when used in this specification, the terms “comprise”, “include”, “contain”, or “have” when used in this specification indicates the presence of the stated feature, figure, step, element, or combination thereof, but does not exclude the presence or inclusion of one or more other features, figures, steps, elements, or combinations thereof.

In this document, when describing the structure of a component with reference to the accompanying drawings, the terms “upper”, “lower”, “upper layer”, “lower layer” and the like refer to the relative position relationship of the component and are not limited to the structure shown in the accompanying drawings.

Hereafter, the multilayer inductor of the present invention will be described.

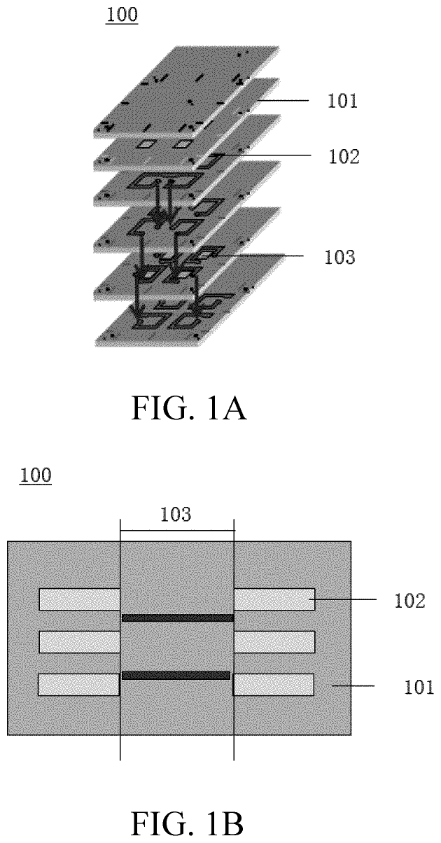

First, referring to FIG. 1A, which illustrates a schematic perspective view of a multilayer inductor structure in the prior art. The multilayer inductor or multilayer inductor structure 100 comprises a plurality of magnetic layers 101, and a plurality of metal electrode tracks 102 formed on the plurality of magnetic layers. The metal electrode tracks formed by individual magnetic layers are in a coil pattern. The center of the coil pattern corresponds to the “magnetic core area” 103 described in the present invention.

In this regard, referring to FIG. 1B, which illustrates a (partial) schematic cross-sectional view of a multilayer inductor structure 100 in the prior art, in which like references indicate like components. As can be seen in FIG. 1B, the “magnetic core area” 103 described herein refers to the central area surrounded by the coil.

The ceramic-inorganic material composite of the present invention can be located at any position in the magnetic core area 103, such as the position shown in the long black area of FIG. 1B.

As described above, in the first aspect, the present invention provides a ceramic-inorganic material composite for multilayer inductor, which is located in the magnetic core area of metal electrode tracks present in the pattern of coils and comprises two or more first layers and second layers, wherein the first layers comprise a ceramic material having a positive slope of the dielectric constant versus temperature curve, the second layers comprise an inorganic material having a negative slope of the dielectric constant versus temperature curve, and the first layers and the second layers are stacked on each other in an alternating manner.

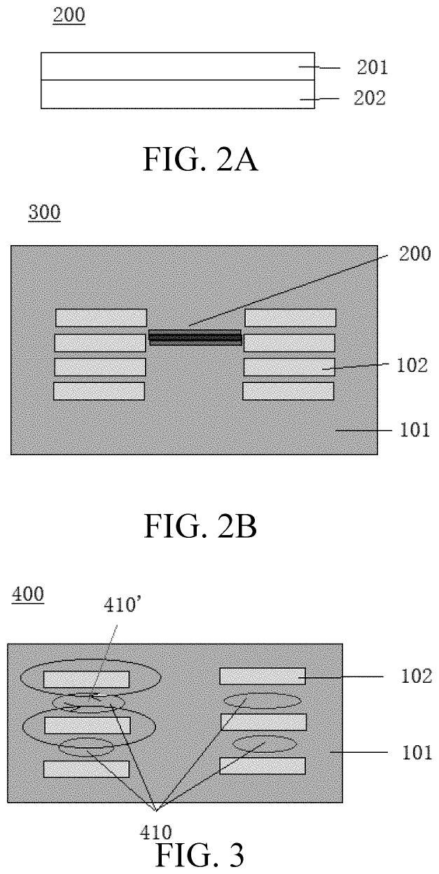

In this regard, referring to FIG. 2A, which illustrates a schematic cross-sectional view of the ceramic-inorganic material composite of the present invention. The ceramic-inorganic material composite 200 comprises two layers, a first layer 201 and a second layer 202, wherein the first layer 201 comprises a ceramic material having a positive slope of the dielectric constant versus temperature curve, and the second layer 202 comprises an inorganic material having a negative slope of the dielectric constant versus temperature curve.

Here, “slope of the dielectric constant versus temperature curve” has the meaning of rate of change of the dielectric constant of the material in the dielectric constant versus temperature curve as it becomes larger or smaller with temperature. If it becomes larger, the slope is positive, and vice versa.

Preferably, the ceramic material having a positive slope in a curve of the dielectric constant versus temperature has a slope between 0.1 and 1; and the inorganic material having a negative slope in a curve of the dielectric constant versus temperature has a slope between −0.1 and 0.05.

Although only a ceramic-inorganic material composite having a two-layer structure is illustrated in FIG. 2A, the ceramic-inorganic material composite of the present invention may comprise two or more first layers and second layers. Moreover, when two or more first and second layers are included, the first and second layers are laminated to each other in an alternating manner, i.e., in a manner of “first layer/second layer/first layer/second layer”.

The ceramic-inorganic material composite 200 shown in FIG. 2A can be located at any position in the magnetic core area of the multilayer inductor, such as the long black position of the magnetic core area 103 shown FIG. 1B.

After embedding the magnetic core area of the multilayer inductor, the ceramic material having a positive slope in a curve of the dielectric constant versus temperature and the inorganic material having a negative slope in a curve of the dielectric constant versus temperature overlap each other to eliminate the deviation of the dielectric constant of the core with current, temperature and frequency, thus realizing a multilayer inductor structure body with stable characteristics.

In the first aspect, it further relates to a multilayer inductor comprising a plurality of magnetic layers and metal electrode tracks formed on the magnetic layers, wherein a ceramic-inorganic material composite is placed in the magnetic core area in the pattern of coils formed by the metal electrode tracks, the ceramic-inorganic material composite comprises two or more first layers and second layers, wherein the first layers comprise a ceramic material having a positive slope in a curve of the dielectric constant versus temperature, the second layers comprise an inorganic material having a negative slope in a curve of the dielectric constant versus temperature, and the first layers and the second layers are stacked on each other in an alternating manner.

FIG. 2B is a schematic cross-sectional view of the multilayer inductor structure comprising the ceramic-inorganic material composite of the present invention. In the multilayer inductor 300, the ceramic-inorganic material composite 200 comprising a plurality of first and second layers is disposed in the magnetic core region. In this regard, as previously described, the ceramic-inorganic material composite 200 may be located at any position in the magnetic core area and is not limited to the position shown in FIG. 2B.

In such aspect, in this field, almost all commonly used ceramic materials are ceramic materials having a positive slope in a curve of the dielectric constant versus temperature, and thus they can be used as the ceramic materials herein. Usually, the ceramic materials having a positive slope in a curve of the dielectric constant versus temperature can be commercially available materials, such as titanium dioxide, zirconium dioxide, etc.

The inorganic material having a negative slope in a curve of the dielectric constant versus temperature can be selected from commercially available materials, such as calcium carbonate, calcium bicarbonate, calcium oxide, etc.

The metal electrode comprises silver (Ag), platinum (Pt), palladium (Pd), copper (Cu), gold (Au), nickel (Ni), or alloys thereof, or composites thereof.

The material of the magnetic layers can be a magnetic material, e.g., a magnetic ceramic material, pertaining a main category of ferrite material, preferably a nickel-zinc-copper ferrite material. For example, ferrite powders comprise iron oxide powder, zinc oxide powder, copper oxide powder, nickel oxide powder, bismuth oxide powder, and a small amount of silicon oxide powder.

The ceramic-inorganic material composite of the present invention can be prepared by a method as follows:

A ceramic material having a positive slope in a curve of the dielectric constant versus temperature (and optional modifying agent) and an inorganic material having a negative slope in a curve of the dielectric constant versus temperature (and optional modifying agent) are dissolved in a solvent for dispersion to obtain a slurry A containing the ceramic material having a positive slope in a curve of the dielectric constant versus temperature and a slurry B containing the inorganic material having a negative slope in a curve of the dielectric constant versus temperature. Then, the slurries A and B are alternately applied to the substrate and sintered at high temperature to obtain the ceramic-inorganic material composite.

In the above production method, the solvent used can be selected from ethyl cellulose and pine alcohol.

In the above production method, the ceramic and inorganic materials used are as described above.

In the above production method, the purpose of adding the modifying agent is to change the surface energy and activity of the slurry particle surface, so that the resulting product is less prone to agglomeration which may affect the processing quality. The modifying agent is preferably M1159 material from FERRO, and preferably, the modifying agent is stirred together with the ceramic material or inorganic material before adding into the solvent.

In the above production method, the dispersion process is carried out using a ball mill for 3 to 5 hours, for example 4 hours.

In the above production method, the substrate is a magnetic substrate for magnetic layers used in the multilayer inductor.

In the above production method, the slurries A and B are alternately printed on the substrate by an alternating printing process.

In the above production method, the sintering temperature is from 800° C. to 950° C., for example 900° C., and the time may be a suitable time commonly used in the art.

In the second aspect, a multilayer inductor comprising a plurality of magnetic layers and metal electrode tracks formed on the magnetic layers, wherein the metal electrode tracks are arranged in such a way that the void space between two adjacent metal electrode tracks where no effective magnetic lines of force exist is minimized is provided.

Referring to FIG. 3, the multilayer inductor 400 comprises a plurality of magnetic layers 101 and metal electrode tracks 102 formed thereon. The plurality of metal electrode tracks 102 are arranged substantially parallel to each other. Due to the large thickness of the magnetic band used to form the magnetic layers, typically 100 μm or more, a large space exists between the metal electrode tracks 102 of two adjacent layers. In such a space, the applicant found that there is no contribution to the performance of the device, because no effective magnetic lines of force exist therein when the device is in use. Therefore, herein, the space between two adjacent layers of metal electrode tracks 102 where no effective magnetic lines of force exist is referred to as a “void space”, as indicated by the reference 410 in FIG. 3.

Specifically, referring to the left side of FIG. 3, the magnetic lines of force generated by the metal electrode tracks of the upper layer and the metal electrode tracks of the middle layer are in opposite directions when the device is in use. For example, the magnetic lines of force generated by the metal electrode track of the upper layer are shown in FIG. 3 in a clockwise direction, while the magnetic lines of force generated by the metal electrode track of the middle layer are in a counterclockwise direction. Thus, in the void space 410′ therebetween, the magnetic lines of force of the two layers of metal electrode tracks will cancel each other out, resulting in a void space where no effective magnetic lines of force exist.

In the present invention, the applicant has found that the void space between two adjacent metal electrode tracks where no effective magnetic lines of force exist can be minimized by changing the arrangement of the metal electrode tracks, thereby enhancing the performance of the multilayer inductor device.

According to the second aspect, as the solution 1, the metal electrode tracks can be arranged in such a way that multilayer metal electrode tracks of the multilayer inductor are closely arranged in the vertical direction, so that the overall thickness of the magnetic layers between the metal electrode tracks is 100 μm or less.

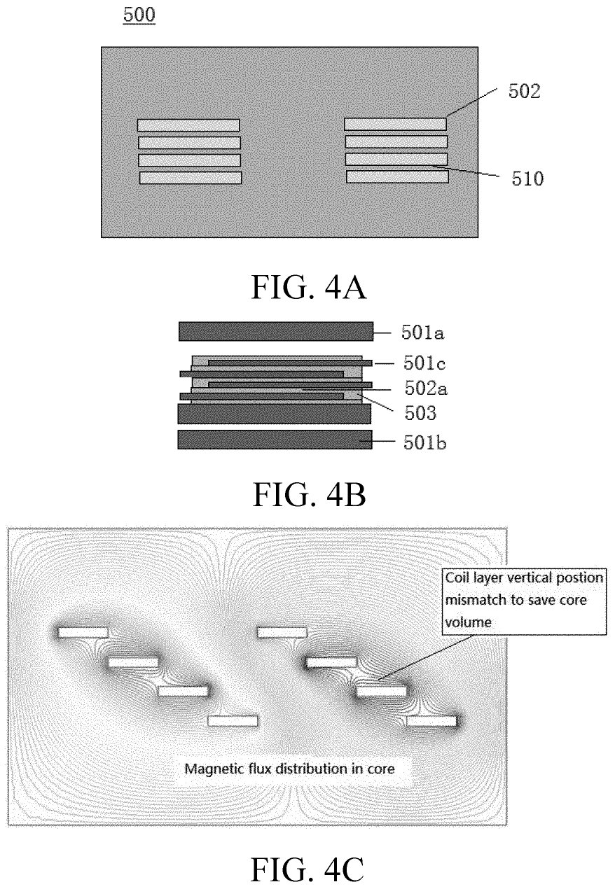

FIG. 4A illustrates a schematic cross-sectional view of multilayer metal electrode tracks of solution 1. As shown in FIG. 4A, a plurality of metal electrode tracks 502 are closely arranged in the vertical direction, and the thickness of the magnetic layer space 510 between the metal electrode tracks is compressed to 100 μm or less. Preferably, the thickness of the magnetic layer space 510 is 50 μm or less, such as 10 μm to 50 μm.

FIG. 4B illustrates a partially enlarged view of the metal electrode track structure of solution 1. As described above, such closely arranged metal electrode track structure can be formed by printing, etching, laser, etc. Preferably, the structure shown in FIG. 4B can be formed using a multiple printing technique.

Specifically, no metal electrode tracks are formed in the bottommost magnetic layer 501b. Then, a layer of metal electrode tracks, e.g., 502a, is first formed on the next lower layer using a multiple printing technique, and another magnetic layer 501c is printed on top of the metal electrode tracks. This procedure is repeated until multiple layers (e.g., 3 or 4 layers) of metal electrode tracks and magnetic layers are formed, in which 502a and 501c are laminated on top of each other. In addition, the two layers of metal electrode tracks 502a can be connected by mesh 503. As the mesh, an aluminum alloy mesh can be used with intermediate openings of 0.01 to 0.1 millimeter (mm) thickness and a tensile strength of 35 to 50 Newtons (N).

The process of the multiple printing technique is as follows:

First, a slurry for the magnetic layer is prepared. Here, a binder, dispersant, defoamer and ceramic powder (ferrite material) are added separately to the solvent and dispersed in a ball mill for 3 to 8 hours (h) to produce a slurry with a viscosity of 200 to 600 centipoise (CPS).

The solvent, binder, dispersant, defoamer and the like used to prepare the slurry can be materials commonly used in the art and will be omitted from description here.

Subsequently, the slurry for forming the magnetic layer and the metal slurry (e.g. silver slurry) are printed in stacking manner by using a mesh, according to the design requirements. The specific process steps are as follows:

(1) The thickness of the magnetic or metallic layer is 5 μm or less for each printing and is dried by baking at 50 ° C. to 70 ° C. for 1 h after each printing, resulting in a multilayer structure, i.e., multilayer metallic electrodes or multilayer magnetic layers, with a total thickness of 100 μm or less,

(2) A mesh structure (e.g., ½, ⅓, ¼ mesh) is used for the connection points of the metal electrode tracks to ensure that the metal electrode tracks between different layers can form a complete coil.

Secondly, according to the second aspect, as the solution 2, the metal electrode tracks are arranged in such a way that multilayer metal electrode tracks of the multilayer inductor are arranged in a stepwise mismatch on a cross section perpendicular to the plurality of magnetic layers. Specifically, with respect to the metal electrode tracks of a lower layer, the metal electrode tracks of an upper layer are mismatched to the left or right layer by layer in a step-like manner.

In this regard, firstly, referring to FIG. 1B, on one side (left or right side of the figure) of the multilayer inductor, the multilayer metal electrodes in the prior art are arranged in alignment with each other in the vertical direction. However, the applicant found that, by mismatching the multilayer metal electrode tracks in a step-like manner, the void space where no effective magnetic lines of force exist can be minimized even without reducing the thickness of the magnetic layers between the multilayer metal electrode tracks.

FIG. 4C is a schematic cross-sectional view of a multilayer inductor structure formed by mismatched multilayer metal electrode tracks and the distribution of magnetic lines of force therein. Referring to FIG. 4C, the metal electrode tracks are arranged in such a way that multilayer metal electrode tracks of the multilayer inductor are mismatched to the left layer by layer in a step-like manner on a cross section perpendicular to the plurality of magnetic layers. Specifically, with respect to the metal electrode tracks of a lower layer, the metal electrode tracks of an upper layer are mismatched to the left layer by layer in a step-like manner. However, although FIG. 4C illustrates the case of mismatching to the left, the present invention also includes the case in which the multilayer metal electrode tracks are mismatched to the right in a step-like manner.

As shown in FIG. 4C, by mismatching the multilayer metal electrode tracks, even if the thickness of the magnetic layers is kept thicker (e.g., 20 μm or more), the void space can be greatly reduced, thereby improving the device performance.

Depending on the difference in device design, the metal electrode tracks of the upper layer are mismatched to the left or right at different distances with respect to the metal electrode tracks of the lower layer.

In the second aspect, the metal electrode comprises silver (Ag), platinum (Pt), palladium (Pd), copper (Cu), gold (Au), nickel (Ni), or alloys thereof, or composites thereof.

The material of the magnetic layers can be a magnetic material, e.g., a ceramic material having magnetic property, the main category of which is a ferrite material, preferably a nickel-zinc-copper ferrite material.

As described above, the third aspect of the present invention provides a combination of the first and second aspects, i.e., a multilayer inductor comprising a plurality of magnetic layers and metal electrode tracks formed on the magnetic layers, wherein a ceramic-inorganic material composite is placed in the magnetic core area in the pattern of coils formed by the metal electrode tracks, the ceramic-inorganic material composite comprises two or more first layers and second layers, wherein the first layers comprise a ceramic material having a positive slope in a curve of the dielectric constant versus temperature, the second layers comprise an inorganic material having a negative slope in a curve of the dielectric constant versus temperature, and the first layers and the second layers are stacked on each other in an alternating manner; and the metal electrode tracks are arranged in such a way that the void space between two adjacent metal electrode tracks where no effective magnetic lines of force exist is minimized.

Characteristics of the ceramic-inorganic material composite and the arrangement of the metal tracks are the same as in the first aspect and/or the second aspect, and thus the detailed descriptions thereof are omitted herein.

### Examples

In the following, the present invention will be explained in detail with reference to examples. However, examples of the present invention may be modified into various other types, and the scope of the present invention should not be limited to the embodiments described below. The examples of the present invention are provided for the purpose of explaining the invention in its entirety to a person having ordinary knowledge in the art.

### Comparative Example 1: Prior Art Multilayer Inductor

A prior art multilayer inductor, having the structure shown in FIG. 1B, was prepared.

Example 1: The multilayer inductor of the present invention (comprising a ceramic-inorganic material composite and closely arranged multilayer metal electrode tracks)
Raw material: ultra-fine ferrite powder, supplied by Bao steel.
Oily organics:
Solvent: Ethyl acetate and isopropanol
Dispersant: Polyethylene glycol, DuPont
DBP plasticizer: Ferro, USA
Equipment and instruments:
Ball mill: zirconia planetary four jar ball mill
Test cast machine: 3 m long testing machine, manufacturer: Fenghua Hi-Tech WK3260 series DC source and inductance test instrument
Agilent4396 spectrum analyzer

### (1) Preparation of Magnetic Body

By using the ultra-fine ferrite powder as raw material and the above-mentioned oily organic substances as additives, the slurry was prepared by ball milling process and the magnetic body was prepared by the test cast machine.

### (2) Preparation of Metal Electrode Tracks and Ceramic-Inorganic Material Composite

Each of titanium dioxide and limestone powders were dissolved in ethyl cellulose and pine oil alcohol as solvents, and a modifying agent (e.g., M1159 material from FERRO) was added, followed by ball milling for 4 hours using a ball mill to obtain two slurries: a titanium dioxide-based ceramic body with a positive temperature coefficient of dielectric constant based on, and a limestone-based inorganic body with a negative dielectric constant.

Then, by using an alternating printing process, the two slurries were printed on the core substrate, respectively, and this composite ceramic body was obtained by high temperature sintering at about 900° C.

The closely arranged multilayer electrode structure was obtained as follows:

Each of a binder, dispersant, defoamer and ceramic powder was added in a ball mill and subjected to ball milling for 8 h to produce a slurry with a viscosity of 400 CPS, thereby obtaining a slurry for forming the magnetic layer.

A silver slurry was used as the material for forming the electrode tracks. The slurry for magnetic layer and the silver slurry were stacked and printed by using a silver mesh, according to the design requirements. The specific process steps were as follows:

For the magnetic layers and metal track layers, the thickness of each printing is 5 μm or less, and each printing needs to be baked at 60° C. for 1 hour after each printing. If the layer thickness does not reach the requirement, several times of printing and baking were performed.

A silver mesh structure (e.g., ½ mesh) was used for the connection points of silver electrode tracks to ensure that the silver electrode between different layers can form a complete coil.

### (3) Preparation of Multilayer Inductor

The magnetic body, metal electrode tracks, and ceramic-inorganic material composite were pressed together and sintered at 900° C. to obtain a multilayer inductor. The resulting multilayer inductor contained the ceramic-inorganic material composite and closely arranged metal electrode tracks as described above.

### 4) Measurement of Performances

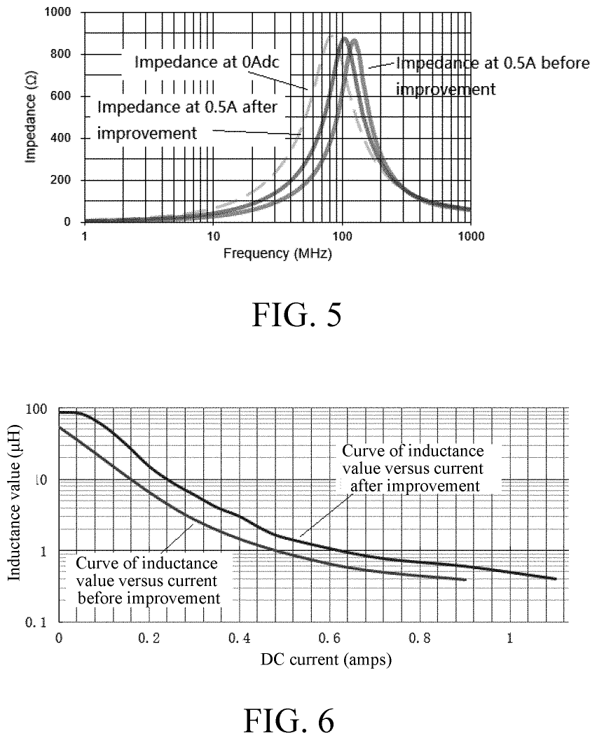

Using the WK3260 series DC source and inductance test instrument and Agilent 4396 spectrum analyzer, electrical performances of the products obtained from Comparative Example 1 and Example 1 were tested, and the results are shown in each of FIG. 5 and FIG. 6, respectively.

As seen in FIG. 5, the fluctuation of the total dielectric constant with mild AC current of multilayer inductors was improved by providing the ceramic-inorganic material composite of this specification. It is estimated that the improvement was about 15%.

As seen in FIG. 6, the inductance of the device was improved by the closely arranged multilayer electrode track structure described herein. In addition, it is estimated that the available magnetic capacity of the magnetic core was increased by about 10%, and the DC resistance was decreased by about 5%.

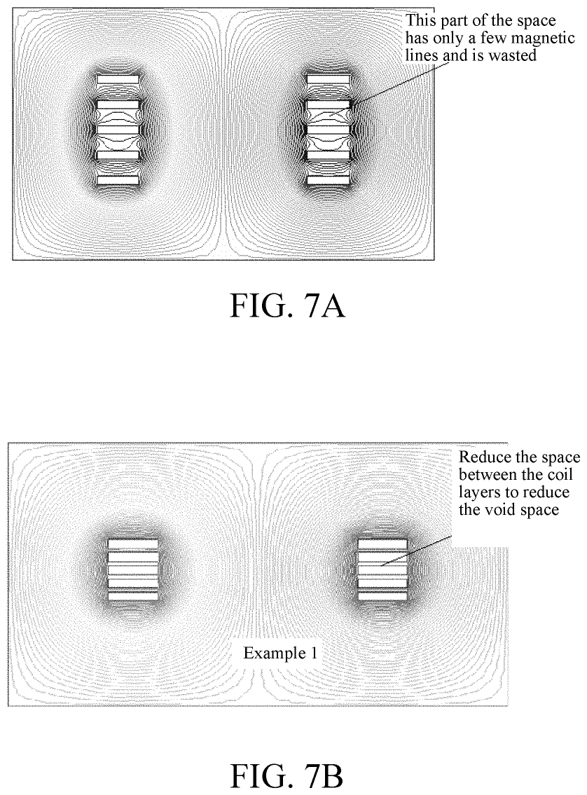

In addition, as seen in FIGS. 7A and 7B, the closely arranged multilayer electrode track structure described herein greatly reduced the void space in the multilayer inductor where no effective magnetic lines of force exist, thereby improving the performance of the device.

### Example 2: Multilayer Inductor Containing Mismatched Arrangement of Multilayer Metal Electrodes

The multilayer inductor containing mismatched arrangement of multilayer metal electrodes of this example was prepared in a similar manner as in Example 1, except that the multilayer metal electrodes were formed into the mismatched structure shown in FIG. 4C.

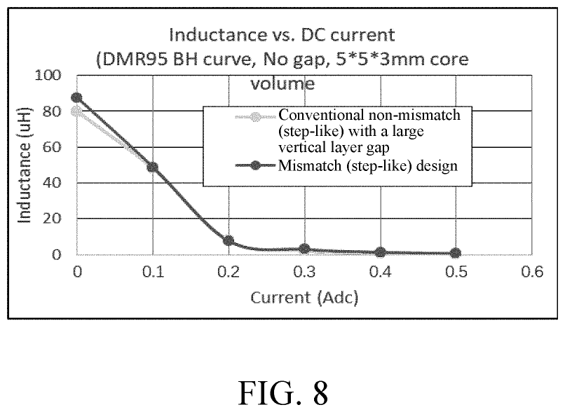

Using the WK3260 series DC source and inductance test instrument and Agilent 4396 spectrum analyzer, electrical performances of the products obtained from Comparative Example 1 and Example 2 were tested, and the results are shown in FIG. 8.

Referring to FIG. 8, the inductance was improved by the vertical mismatch structure of coil layers. In addition, it is estimated that the flux volume utilization achieved an optimization of about 5% to 10%.

With the aid of the teachings present in the foregoing specification and related accompanying drawings, one of skill in the art will be aware of a variety of variations and other embodiments of the technical solutions described herein. Accordingly, it will be understood that the present invention is not limited to the particular embodiments disclosed and that any variations and other embodiments are deemed to be included within the scopes of the appended claims.

1. A ceramic-inorganic material composite for a multilayer inductor, which is located in a magnetic core area of metal electrode tracks present in a pattern of coils and comprises two or more first layers and second layers, wherein the first layers comprise a ceramic material having a positive slope in a curve of the dielectric constant versus temperature, the second layers comprise an inorganic material having a negative slope in a curve of the dielectric constant versus temperature, and the first layers and the second layers are stacked on each other in an alternating manner.

2. The ceramic-inorganic material composite according to claim 1, wherein the ceramic material having a positive slope in a curve of the dielectric constant versus temperature is titanium dioxide or zirconium dioxide.

3. The ceramic-inorganic material composite according to claim 1, wherein the inorganic material having a negative slope in a curve of the dielectric constant versus temperature is calcium carbonate, calcium bicarbonate, or calcium oxide.

4. The ceramic-inorganic material composite according to claim 1, wherein the metal electrode comprises silver (Ag), platinum (Pt), palladium (Pd), copper (Cu), gold (Au), nickel (Ni), or alloys thereof, or composites thereof.

5. The ceramic-inorganic material composite according to claim 1, wherein:
the ceramic material having a positive slope in a curve of the dielectric constant versus temperature is titanium dioxide or zirconium dioxide; and
the inorganic material having a negative slope in a curve of the dielectric constant versus temperature is calcium carbonate, calcium bicarbonate, or calcium oxide.

6. A multilayer inductor comprising the ceramic-inorganic material composite according to claim 1, a plurality of magnetic layers and metal electrode tracks formed on the magnetic layers, wherein the ceramic-inorganic material composite is disposed in the magnetic core area formed by the metal electrode tracks in the pattern of coils.

7. The multilayer inductor according to claim 6, wherein:
the ceramic material having a positive slope in a curve of the dielectric constant versus temperature is titanium dioxide or zirconium dioxide; and/or
the inorganic material having a negative slope in a curve of the dielectric constant versus temperature is calcium carbonate, calcium bicarbonate, or calcium oxide.

8. The multilayer inductor according to claim 6, wherein the metal electrode tracks are arranged in such a way that the void space having no effective magnetic lines of force between two adjacent metal electrode tracks is minimized.

9. The multilayer inductor according to claim 6, wherein the metal electrode tracks are arranged in such a way that the metal electrode tracks of the multilayer inductor are closely arranged in the vertical direction, so that an overall thickness of the magnetic layers between the metal electrode tracks is 100 μm or less.

10. The multilayer inductor according to claim 6, wherein the metal electrode tracks are arranged in such a way that the metal electrode tracks of the multilayer inductor are mismatched and arranged in a step-like manner on a cross section perpendicular to the plurality of magnetic layers.

11. The multilayer inductor according to claim 6, wherein, with respect to the metal electrode track of a lower layer, the metal electrode track of an upper layer are mismatched to the left or right, layer by layer, in a step-like manner.

12. The multilayer inductor according to claim 6, wherein:
the ceramic material having a positive slope in a curve of the dielectric constant versus temperature is titanium dioxide or zirconium dioxide;
the inorganic material having a negative slope in a curve of the dielectric constant versus temperature is calcium carbonate, calcium bicarbonate, or calcium oxide;
the metal electrode tracks are arranged in such a way that the void space having no effective magnetic lines of force between two adjacent metal electrode tracks is minimized;
the metal electrode tracks are arranged in such a way that the metal electrode tracks of the multilayer inductor are closely arranged in the vertical direction, so that an overall thickness of the magnetic layers between the metal electrode tracks is 100 μm or less;
the metal electrode tracks are arranged in such a way that the metal electrode tracks of the multilayer inductor are mismatched and arranged in a step-like manner on a cross section perpendicular to the plurality of magnetic layers; and
with respect to the metal electrode track of a lower layer, the metal electrode track of an upper layer are mismatched to the left or right, layer by layer, in a step-like manner.

13. A multilayer inductor comprising a plurality of magnetic layers and metal electrode tracks formed on the magnetic layers, wherein the metal electrode tracks are arranged in such a way that the void space having no effective magnetic lines of force between two adjacent metal electrode tracks is minimized.

14. The multilayer inductor according to claim 13, wherein the metal electrode tracks are arranged in such a way that the metal electrode tracks of the multilayer inductor are closely arranged in the vertical direction, so that an overall thickness of the magnetic layers between the metal electrode tracks is 100 μm or less.

15. The multilayer inductor according to claim 13, wherein the metal electrode tracks are arranged in such a way that the metal electrode tracks of the multilayer inductor are mismatched and arranged in a step-like manner on a cross section perpendicular to the plurality of magnetic layers.

16. The multilayer inductor according to claim 13, wherein, with respect to the metal electrode track of a lower layer, the metal electrode track of an upper layer are mismatched to the left or right, layer by layer, in a step-like manner.

17. The multilayer inductor according to claim 13, wherein:
the metal electrode tracks are arranged in such a way that the metal electrode tracks of the multilayer inductor are closely arranged in the vertical direction, so that an overall thickness of the magnetic layers between the metal electrode tracks is 100 μm or less;
the metal electrode tracks are arranged in such a way that the metal electrode tracks of the multilayer inductor are mismatched and arranged in a step-like manner on a cross section perpendicular to the plurality of magnetic layers; and
with respect to the metal electrode track of a lower layer, the metal electrode track of an upper layer are mismatched to the left or right, layer by layer, in a step-like manner.

18. A multilayer inductor comprising a plurality of magnetic layers and metal electrode tracks formed on the magnetic layers, wherein:
a ceramic-inorganic material composite is disposed in a magnetic core area formed by the metal electrode tracks in a pattern of coils;
the ceramic-inorganic material composite comprises two or more first layers and second layers;
the first layers comprise a ceramic material having a positive slope in a curve of the dielectric constant versus temperature;
the second layers comprise an inorganic material having a negative slope in a curve of the dielectric constant versus temperature;
the first layers and the second layers are stacked on each other in an alternating manner; and
the metal electrode tracks are arranged in such a way that the void space having no effective magnetic lines of force between two adjacent metal electrode tracks is minimized.

19. The multilayer inductor according to claim 18, wherein the metal electrode tracks are arranged in such a way that the metal electrode tracks of the multilayer inductor are closely arranged in the vertical direction, so that an overall thickness of the magnetic layers between the metal electrode tracks is 100 μm or less.

20. The multilayer inductor according to claim 18, wherein the metal electrode tracks are arranged in such a way that the multilayer metal electrode tracks of the multilayer inductor are mismatched and arranged in a step-like manner on a cross section perpendicular to the plurality of magnetic layers.

21. The multilayer inductor according to claim 18, wherein, with respect to the metal electrode track of a lower layer, the metal electrode track of an upper layer are mismatched to the left or right, layer by layer, in a step-like manner.

22. The multilayer inductor according to claim 18, wherein:
the ceramic material having a positive slope in a curve of the dielectric constant versus temperature is titanium dioxide or zirconium dioxide; and
the inorganic material having a negative slope in a curve of the dielectric constant versus temperature is calcium carbonate, calcium bicarbonate, or calcium oxide.

23. The multilayer inductor according to claim 18, wherein:
the ceramic material having a positive slope in a curve of the dielectric constant versus temperature is titanium dioxide or zirconium dioxide;
the inorganic material having a negative slope in a curve of the dielectric constant versus temperature is calcium carbonate, calcium bicarbonate, or calcium oxide;
the metal electrode tracks are arranged in such a way that the metal electrode tracks of the multilayer inductor are closely arranged in the vertical direction, so that an overall thickness of the magnetic layers between the metal electrode tracks is 100 μm or less;
the metal electrode tracks are arranged in such a way that the metal electrode tracks of the multilayer inductor are mismatched and arranged in a step-like manner on a cross section perpendicular to the plurality of magnetic layers; and
with respect to the metal electrode track of a lower layer, the metal electrode track of an upper layer are mismatched to the left or right, layer by layer, in a step-like manner.
